(19) United States
(12) Patent Application Publication
(10) Pub. No.: US 2012/0066369 A1
(43) Pub. Date: Mar. 15, 2012

(54) METHOD FOR ASSIGNING A NETWORK ADDRESS FOR COMMUNICATING IN A SEGMENTED NETWORK

(75) Inventors: Armand Michel Marie Lelkens, Eindhoven (NL); Bozena Erdmann, Eindhoven (NL)

(73) Assignee: KONINKLIJKE PHILIPS ELECTRONICS N.V., EINDHOVEN (NL)

(21) Appl. No.: 13/319,769

(22) PCT Filed: Apr. 30, 2010
(86) PCT No.: PCT/IB2010/051899

§ 371 Date: Nov. 10, 2011

(30) Foreign Application Priority Data
May 13, 2009 (EP) 09305426.0

(51) Int. Cl. G06F 15/16; H04W 8/00

(52) U.S. Cl. 709/223

(57) ABSTRACT

The present invention relates to a method for assigning a network address to a first node in a network comprising a plurality of second nodes, the method comprising the steps of: (a) assigning a stochastic address to the first node, (b) the first node transmitting an announcement message to a first control device, (c) the first control device checking whether the assigned network address is available, and (d) upon detecting that the assigned address is not available, the first control device transmitting a message requesting the change of the assigned address

### FIELD OF THE INVENTION

The present invention relates to a method for communicating in a network, comprising a plurality of nodes, and such nodes. This invention is more especially related to ad hoc networks and that may comprise a plurality of sub-networks interconnected to each other by a backbone.

This invention is, for example, relevant for Zigbee networks.

### BACKGROUND OF THE INVENTION

Ad hoc networks, like a ZigBee network, are often limited with large scale network deployment where hundreds and thousands of sensors and controllers in commercial buildings need to be fully connected. The root cause of the scalability problem in large-scale networks, like a large scale Zigbee network, is the so-called “broadcast storm” problem where ongoing broadcasting interferes with parallel unicast packet traversals. In order to reduce the consequence of a broadcast storm, instead of connecting all devices using one single ZigBee network, it is proposed to use a “Scalable Hybrid and Integrated Network” concept where a single logical ZigBee network is divided physically into a number of ZigBee segments that are connected by some high bandwidth backbone technologies, such as Ethernet or Wi-Fi. This is illustrated with FIG. 1.

In the ZigBee bridging specification, a ZigBee Bridging Device (ZBDs) is an entity that connect physically separated ZigBee segments into one logical ZigBee networks transparently. To achieve transparency with regard to backbone technologies, a ZBD encapsulates every ZigBee packet it receives in an IP packet and tunnel it towards a destination ZBD where the encapsulated ZigBee packet is unpacked without modifications.

However, the ZigBee bridging devices do not provide full support for scalability. Indeed, in a bridged ZigBee network, logically all ZigBee network segments or sub-networks are considered as one ZigBee network where every node share the same ZigBee PAN network ID and share the same ZigBee network address space. This is achieved by transparent bridging done at ZBDs. Transparent bridging also implies that rebroadcasting will take place in every other segments for a broadcast originated from one segment. While this is necessary for data broadcasting that needs to reach every ZigBee devices on a network, this is unnecessary for some of the control packets. For example, when a routing discovery packet for a particular node is sent, only the segment that contains the particular node need to be flooded with the broadcasting of the packet. Broadcasting to other segments is unnecessary and will not yield any useful result.

In a large network, overhead in maintaining network connectivity is large. This leads to large number of control packets being transmitted in broadcast mode. These include among other things Device Announcement and Route Discovery commands. Therefore suppressing unnecessary flooding of control packets in every segment becomes necessary to reach full scalability. Such flooding is especially present in case of address collision, i.e. when a new address selected by a node for being identified in the network is really in use by another node.

### SUMMARY OF THE INVENTION

It is an object of the invention to propose a method for reducing the signalling required to solve address collision.

It is another object of the invention to propose a network where the address collision is solved with minimal signalling.

In accordance with a first aspect of the invention, a method is proposed for assigning a network address to a first node in a network comprising a plurality of second nodes, the method comprising the steps of:

(a) assigning a stochastic address to the first node,

(b) the first node transmitting an announcement message to a first control device,

(c) the first control device checking whether the assigned network address is available, and

(d) upon detecting that the assigned address is not available, the first control device transmitting a message requesting the change of the assigned address.

In accordance with a second aspect of the invention, it is proposed a control device comprising communication means for communicating in a network comprising a plurality of nodes, the control device comprising

means for receiving an announcement message from a first node, said message including an assigned network address of the first node,

checking means for checking whether the assigned network address is available, and

transmitting means for, upon detecting that the assigned address is not available, transmitting to the first node a message requesting the change of the assigned address.

As a consequence, this process enables a short and efficient selection of new address in case of conflicts. It also permits to avoid the transmission of a plurality of new address attempts. Indeed, when the network comprises a large number of nodes, the probability of selecting an already used address is high, and this new method enables a quick resolution of address conflicts with low overhead.

These and other aspects of the invention will be apparent from and will be elucidated with reference to the embodiments described hereinafter.

### BRIEF DESCRIPTION OF THE DRAWINGS

The present invention will now be described in more detail, by way of example, with reference to the accompanying drawings, wherein:

FIG. 1 already described is a block diagram of a segmented network.

FIG. 2 is a block diagram of a network in accordance with an embodiment of the invention.

FIG. 3 is a block diagram of a network in accordance with an embodiment of the invention.

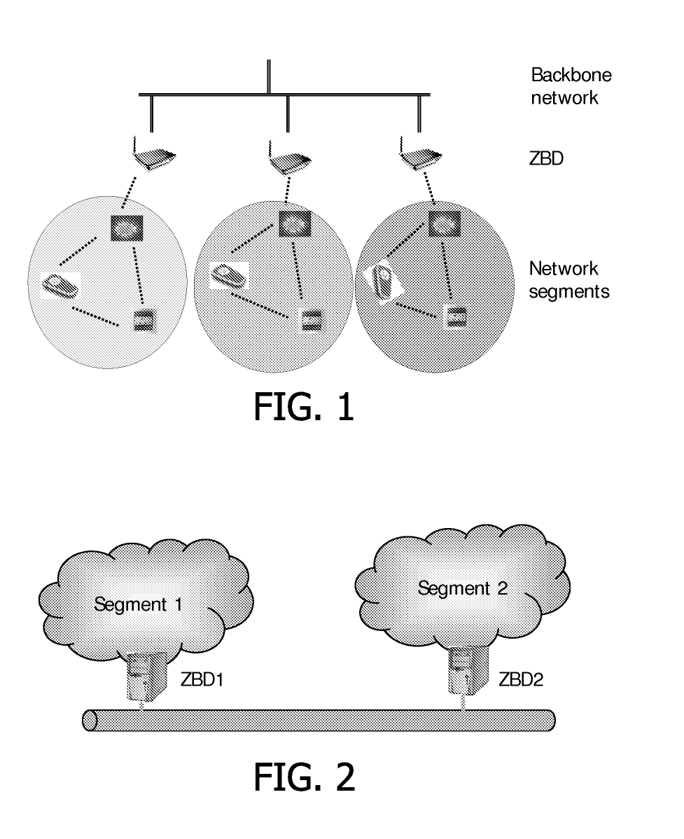

### DETAILED DESCRIPTION OF THE INVENTION

In a ZigBee network stochastic addressing is used where each node gets a random network address within the 16 bit wide address space. After a short check by a parent, whether the address is in conflict with other 16-bit addresses known to the parent (neighbours, bound and infrastructure devices), the node announces the usage of this address by means of a Device_annce broadcast. If any device in the network notices a conflict, i.e. two nodes using the same address, it is reported via broadcast network status message, and subsequently both conflicting nodes get a new random address and broadcast it.

In a large ZigBee network the random address selection can give rise to repetitive conflicts and subsequent transmission of multiple network wide broadcasts. Also, nodes that once established a unique network address can later on be forced to select a new one (if another node happens to select that same address).

The ZigBee alliance foresees two methods to segment a large network into several smaller ones. One is the ZigBee gateway specification, which is not yet ready; and gateway usage will result in independent segments, making inter-segment communication non-transparent or more complicated. The other segmentation of the large network with connections to a backbone via bridges (ZBDs—ZigBee Bridging Devices or segment control device) but these ZBDs are completely transparent and simply pass on all broadcast messages to the backbone and to other segments.

The issue is to improve the addressing by finding a way to limit the scope of the address conflict detection and resolution broadcast to only those part(s) of the network that are really needed.

In accordance with an embodiment of the invention illustrated on FIG. 2, each node assigns itself (in communication with its parent) a stochastic address where the address conflicts are handled per segment and filtered out by this segment's ZBD, without the need for address conflict detection and resolution broadcasting in the entire network. To this end, the ZBDs keep a list of the addresses already in use and can directly respond to Device_annce messages from devices to avoid duplicate usage of addresses. Moreover, using this list of local addresses they can immediately recognise whether messages on the backbone are meant for devices in their segment and then forward them (or, if they are not meant for its segment, ignore them). For each device in the list, there is also the address of the ZBD via which it can be reached with the lowest cost.

In the simplest case, groups of nodes that are within each others radio range share exactly one ZBD to connect to the (exactly one) backbone. It can happen that radio ranges overlap and thus a group of nodes have more than one connecting ZBD to the backbone (also called ‘multi-homed’): Note, that if the radio ranges of the segments overlap, but the segments use a different channel, each node belongs to only one segment and the segments logically do not overlap.

In order to detect such topologies each ZBD shall send out a many-to-one route request to itself (on the ZigBee side). A ZBD receiving such a request for a different node knows that the originator of the request is also a bridging device for the same segment and thus, that the segment is multi-homed.

In order to distinguish between Device_annce messages with equal short addresses sent by the same device in one segment from messages sent by different devices (in the same or another segment) the ZBD shall also keep track of the long MAC addresses. Therefore the information to be stored in the list per node is:

| MAC address | 64-bit long address |
|---|---|
| NWK address | 16-bit short address |
| ClosestZBD | NWK address of the ZBD it has the lowest-cost path to this |
| node : in a single-home segment that's the address of this segment's bridge, and in multi- | |
| homed segments, that's the address of the bridge that has the shortest in-segment route to this | |
| node | |
| Cost | path cost to the node |

In accordance with this embodiment, the procedure to assign unique addresses to the nodes is as follows:

A new node that joins the network, is assigned a stochastic address by its parent, and broadcasts the Device_annce message (SOTA).

A ZBD that receives this broadcast Device_annce message from the ZigBee side looks up the MAC address in its list of used addresses.

i. If it is already in the list, and
if the NWK matches, the ZBD ignores the message;
else if the NWK is different, check this NWK address for conflict, i.e. whether the new NWK address is already in the list, used by a different node with a different 64-bit address.
If it isn't, update the NWK address for this MAC address and broadcasts the message over the backbone to the other ZBDs.
else send a network status command 0x0d to the originator to forbid this node choosing that NWK address.

ii. If it is not already in the list, but the NWK is, it sends a network status command 0x0d to the originator to forbid this node choosing that NWK address. The Device_annce is not forwarded, so the other segments will not notice. The ZBD adds the MAC address to the list, with 16-bit address set to 0xffff (unspecified).

iii. If it is not already in the list and neither is the NWK address, the ZBD adds both to the list and broadcasts the message over the backbone to the other ZBDs.

A ZBD that receives a Device_annce via the backbone checks the MAC address in its list

i. If the MAC-NWK address combination it is already in the list, it ignores the message
ii. If it is not already in the list, but the NWKaddress is (so it is for a different MAC address, the ZBD sends a broadcast? network status command 0x0d on the backbone to the sending ZBD. The Device_annce is not forwarded into the segments, so the devices in the segment will not notice
iii. If it is not already in the list, and neither is the NWKaddress, the ZBD adds it, together with the ZBD from which the message was received as closestZBD.

A ZBD that receives a network status command 0x0d on the backbone, checks the address in its list

i. If the address occurs in the list; it sets the NWKaddress to 0xffff and—if the ZBD's own address is set in the closestZBD field—it forwards the message to this address [it can do this, because the conflict is EXTERNAL, i.e. between different segments, i.e. the address is still unique within the subnet]

ii. If the address is not in the list, the ZBD ignores the message

In a variant of the above embodiment, it has been noticed that

For big networks the list of all used address in the network may grow too large. In an optimization each ZBD only stores addresses in use in their own segment, thus saving on storage space. In multi-homed segments the addresses occur in both (all) ZBDs to which the segment is connected. and those ZBDs will forward traffic.

The downside is that

i. a sending ZBD cannot decide directly to which ZBD a Device_annc message has to be forwarded but has to broadcast it on the backbone always so that the correct ZBD can decide to react on it.

ii. after the ZBD has accepted a new address from a node in its segment, it may still get the address conflict message from another ZBD and has to revoke the address after all (this might also happen in the above case if the Device_annc messages cross each other)

The Device_annce message is extended with a ‘aggregated cost’ field which is incremented with the link cost at each hop, so that the receiving ZBD is informed about the total cost to reach this node. This field is also added to the list entries.

With this optimization, if a ZBD receives a Device_annce message from its segment and find the address in its list, it first checks whether the cost is lower than the previous cost. If so, it updates the record of the address with the new cost and if the closestZBD is different from the current one, it sends the Device_annce message to the other ZBDs to inform them about the new (cheaper) path to that node.

If both optimisations are combined ZBDs can use the cost information (of the second optimisation). to decide which of the ZBDs in a multi-homed segment have the lowest path cost to the node; the other ZBDs can delete this node form their list (according to the first optimisation).

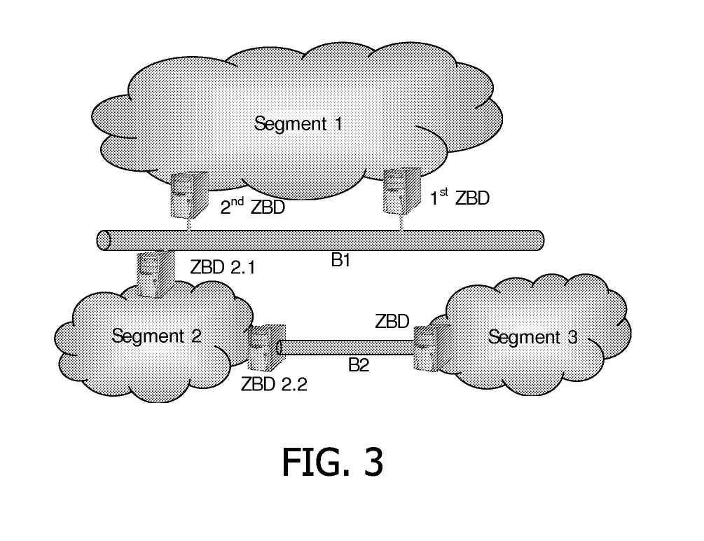

In a variant of this embodiment illustrated on FIG. 3, it can happen that the segments are not connected via one backbone, but via a number of (fragmented) backbones. This would imply, that at least one segment is multi-homed, with at least two ZBDs connected to different backbone fragments, as depicted below.

In this situation a many-to-one route request from ZBD2.1 will be seen by ZBD2.2 and vice versa. Because these ZBDs cannot contact the other via their backbone, they know that they are on different backbones. If they find themselves in such a situation they will forward Device_annce and Network Status 0x0d messages received from their backbone also as (possibly multiple) unicast to the ZBDs from which they have seen a many-to-one route request. In this way, the lists in all ZBDs are synchronised. Similarly, if the shorter list (only local nodes) optimization is used, all the other ZBDs will get the Device_annce message (and respond if the address is already in use in their segment) and the Network Status 0x0d messages.

Another embodiment of the invention is based on the recognition that in the standard ZigBee specification [r17], in order to avoid reduce the probability of address conflicts, a new stochastic address to be used by a joining device (or by a device that has to change address as a result of a collision) is checked for conflict by the parent of the joiner.

This embodiment proposes to extend this procedure, so that this check not only is based on the addresses that occur in the parent's NIB. Also the parent queries the bridge(s) in its segment. If the address is unique, the bridge just approves it, by sending Network Status command with the status of 0x08 (meaning Target Address unallocated). Otherwise, if the address is in conflict; the bridge sends back a free, unique address. This address is taken from an unique address pool, local to the bridge. If the bridge runs out of address, it claims another pool of addresses in cooperation with other bridges.
Some notes on the network status command:
Network status address verification 0x0e unicast to bridge: to verify that a certain destination NWK address belongs to some MAC address, not to check whether it is free.
Network Status command Target Address unallocated 0x08

### Network Address Update 0x10

This embodiment to avoid address conflicts by issuing addresses may comprise
Introduce new DHCP-like request from parent to bridge
Use device_annce unicast to bridge
Device address reservation protocol

In addition, in a variant of this invention, the protocol is specified for the ZBD to align the address pools between themselves automatically, without the need of manual pre-configuration by the user.

Upon joining the network, the new ZBD gets a pool of PoolSize addresses. Pool size could be half of an average segment size, e.g. 50 NWK addresses. The address pool could be assigned to the bridge by the ZC/TC, upon joining the network, i.e. after it sends Device_annce (if its bridge capabilities are indicated there).

Alternatively, the new ZBD discovers all other ZBDs and the address pools used by them, and then chooses a unique pool.

The ZBD can store the pool of addresses assigned to it directly in its NIB AddressMap, with the NWK address field containing the unique address, and the IEEE address field containing 0x0 . . . 000 for unspecified. The ZBD will overwrite the IEEE addresses, as it assigns them to the devices on its segment.

In addition, each parent could keep one free, unique address “on the stock”, to have it for the joining child.

The invention and its embodiments are related to Scalable Hybrid and Integrated Networks for Lighting Control. Lighting control is active in controls in large commercial building. Currently, control networks are wired. Lighting control intends to ship wireless control products in the near future because of the no-wire advantages of wireless networks. ZigBee is the choice for wireless connectivity; however, ZigBee has been reported of limited support for large-scale networks.

Application of the embodiments of the invention can go maturely beyond lighting control to areas/products where large scale wireless sensor networks are desired.

In the present specification and claims the word “a” or “an” preceding an element does not exclude the presence of a plurality of such elements. Further, the word “comprising” does not exclude the presence of other elements or steps than those listed.

The inclusion of reference signs in parentheses in the claims is intended to aid understanding and is not intended to be limiting.

From reading the present disclosure, other modifications will be apparent to persons skilled in the art. Such modifications may involve other features which are already known in the art of radio communication.

1. A method for assigning a network address to a first node in a network comprising a plurality of second nodes, the method comprising:
assigning a stochastic address to the first node,
transmitting, by the first node, an announcement message to a first control device,
checking, by the first control device, whether the assigned network address is available, and
upon detecting that the assigned address is not available, transmitting, by the first control device, a message requesting the change of the assigned address.

2. The method of claim 1, wherein the assigning comprises a parent node of the first node assigning the stochastic address to the first node, wherein the stochastic address is different from a list of already in use addresses stored by the parent node.

3. The method of claim 2, wherein, prior to the assigning, the first node submits a proposed network address, and wherein the parent node assigns the proposed network address as the assigned network address if the proposed network address is not included in the list of already in use addresses.

4. The method of claim 1, wherein the first node transmits the announcement message to the first control device by broadcasting the announcement message to all neighboring nodes.

5. The method of claim 1, wherein the network is subdivided in a plurality of sub-networks interconnected by means of at least one backbone, wherein each sub-network is coupled to the backbone by means of at least one dedicated control device, wherein the first node and the first control device belong to a first sub-network.

6. The method of claim 5, wherein the checking comprises
the first control device checking in a control device list of already in use addresses whether the assigned network address is included in this control device list, and
upon failing to find the assigned network address in the control device list, submitting the network address to other control devices connected to the backbone.

7. The method of claim 6, wherein the checking further comprises the other control devices checking whether the assigned network address is included in their own control device list of already in use addresses.

8. The method of claim 7, wherein the first control device further comprises a list of available network addresses, and wherein the transmitting further comprises
the first control device selecting an available network address from the list of available network addresses, and
transmitting the selected available network address with the message requesting the change of the assigned address.

9. The method of claim 8, further comprising the first node using the selected network address and broadcasting an announcement message to its neighbor nodes, said announcement message including the selected network address.

10. The method of claim 8, wherein each control device comprises respectively a list of available addresses.

11. The method of claim 10, wherein step the transmitting further comprises the first control device checking whether the number of remaining available network addresses in the list of available network addresses is below a threshold, and requesting the network a new list of available addresses.

12. (canceled)

13. A control device comprising communication means for communicating in a network comprising a plurality of nodes, the control device comprising
means for receiving an announcement message from a first node, said message including an assigned network address of the first node,
checking means for checking whether the assigned network address is available, and
transmitting means for, upon detecting that the assigned address is not available, transmitting to the first node a message requesting the change of the assigned address.

14. (canceled)

15. (canceled)
